(19) United States
(12) Patent Application Publication
(10) Pub. No.: US 2005/0010429 A1
(43) Pub. Date: Jan. 13, 2005

(54) Web-based client outcomes and records system

(76) Inventors: Anthony Zipple, Evanston, IL (US); Madeline Becker, Waltham, MA (US); Meischa Gasek, Hopkinton, MA (US); Melissa Martin, Brighton, MA (US); Stephen Michael Boyd, Smithfield, RI (US); Robert S. Straccia, Danvers, MA (US); John Foley III, Stoughton, MA (US); Sudarshan Reddy Putta, Sharon, MA (US); Rejith Krishnan, Foxboro, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/841,280

(22) Filed: May 7, 2004

Related U.S. Application Data
(60) Provisional application No. 60/468,962, filed on May 7, 2003.

(51) Int. Cl. G06F 17/60

(52) U.S. Cl. 705/1; 705/10

(57) ABSTRACT

A software module tracks a program fee for a service provided by a human service provider. The software module determines a total income and a program fee percentage associated with the service and enables a user to input at least one of a deduction, a ceiling, and a personal needs allowance. The software module determines a program fee for the service using the total income, program fee percentage, deduction, ceiling, and/or personal needs allowance.

### FIELD OF THE INVENTION

This invention relates generally to accessing client information, and more specifically to a web-based client outcomes and records system.

### BACKGROUND

Costs associated with the human service industry currently represent a significant portion of the United States Gross National Product, and continue to rise at an exceptional pace. A significant portion of these increased costs results from an inability to appropriately retrieve, coordinate, or target relevant information (e.g., subsidies and program fees) associated with a particular client. For example, a subsidy provider may send a subsidy to a human service provider without indication of which client or clients the subsidy should be directed. Similarly, a program fee for a program offered by the human service provider may vary depending on the particular client. Often, this variation introduces confusion and complexity to tracking a program fee.

### SUMMARY OF THE INVENTION

In at least one aspect, the invention relates to a method for tracking, by a software module, a program fee for a service provided by a human service provider. The method includes the steps of determining a total income and a program fee percentage associated with the service and enabling a user to input at least one of a deduction, a ceiling, and a personal needs allowance. The method also includes determining a program fee for the service using the total income, program fee percentage, deduction, ceiling, and/or personal needs allowance.

In at least one embodiment, the step of determining the total income includes using a previous month income, a current income, a threshold for offset, and/or a yearly income. The determining of the program fee percentage further includes determining a residential percentage, a housing only percentage, and a percentage override. The determining of the residential percentage can also include determining a Department of Mental Retardation (DMR) percentage and/or a Department of Mental Health (DMH) percentage. The determining of the housing only percentage can include determining a supported housing percentage, a subsidy percentage, and/or a supported housing with subsidy percentage.

In at least one embodiment, the residential percentage, the housing only percentage, and the percentage override varies depending on a funding agency, a contract, a type of housing provider, and a type of service provider. In one embodiment, the method includes enabling the user to input an earned income rule. The determining of the deduction can include determining a type of and/or amount of the deduction. Moreover, the deduction can be recurring or a one-time deduction.

In another aspect, a software module to determine a program fee for a service provided to a client by a human service provider includes a total income module calculating a total income for a client of a human service provider and a program fee percentage module calculating a program fee percentage for a service provided to the client by the human service provider. The software module also includes an input module enabling input of a deduction, a ceiling, and/or a personal needs allowance. The software module additionally includes a program fee module determining a program fee for the service using the total income, program fee percentage, deduction, ceiling, and/or personal needs allowance. In one embodiment, the software module includes a collections module determining whether the program fee is collected.

In yet another aspect, the invention relates to a method for maintaining information related to subsidies for clients of a human service provider. The method includes the steps of collecting information related to subsidies for clients of a human service provider, maintaining records for subsidy providers providing subsidies to the clients of the human service provider, and determining, by a subsidy module, which client receives a subsidy from the subsidy information and the subsidy provider records.

In another aspect, the subsidy module includes a client subsidy module collecting information related to subsidies for clients of a human service provider, and a subsidy provider module maintaining records for subsidy providers providing subsidies to the clients of a human service provider. The subsidy module determines which client receives a subsidy from the information related to the subsidies and the subsidy provider records. In one embodiment, the information related to the subsidies includes a rent amount, overall subsidy amount, and annual rent. The records for subsidy providers can include a list of subsidy types.

In at least one embodiment, the subsidy module can include a contract management module maintaining contract records for contracts associated with the subsidies. The contract records can include one or more cost centers attached to a contract associated with a subsidy. In one embodiment, a functional business unit module tracks one or more cost centers. In one embodiment, the functional business unit module is separate from the subsidy module. The subsidy module can also include a reporting module generating reports associated with the subsidies. In some embodiments, the subsidy module includes a subsidy start date, a subsidy end date, and a subsidy recertification date.

### BRIEF DESCRIPTION OF THE DRAWINGS

Advantages of the present invention will become better understood by referring to the following drawings, which show a system according to an illustrative embodiment of the invention and in which:

FIG. 1 is a conceptual block diagram depicting an embodiment of a computer system having a human service provider server to track, maintain, and/or report a program fee and/or a subsidy for clients of a human service provider;

FIG. 2 is a conceptual block diagram depicting an embodiment of a subsidy module of the human service provider server of FIG. 1;

FIG. 3 is a flow diagram depicting an embodiment of the steps performed by the subsidy module of FIG. 2;

FIG. 4 is a conceptual block diagram depicting an embodiment of a program fee module of the human service provider server of FIG. 1;

FIG. 5 is a flow diagram depicting an embodiment of the steps performed by the program fee module of FIG. 4;

FIG. 6 is a more detailed flow diagram depicting an embodiment of additional steps performed by the program fee module of FIG. 4;

FIG. 7 is a block diagram of an embodiment of the medications that the human service provider server can manage;

FIG. 8 is an embodiment of a screen shot of a medication page displayed by the human service provider server.

FIG. 9 is an embodiment of a liquids data entry screen displayed by the human service provider server.

FIG. 10 is an embodiment of the liquids data entry screen of FIG. 9 with data entered.

FIG. 11 is an embodiment of a multi medication data entry screen displayed by the human service provider server.

FIG. 12 is an embodiment of a site setup screen shot of the program fee module displayed by the human service provider server.

FIG. 13 is an embodiment of a financial income screen displayed by the human service provider server.

FIG. 14 is an embodiment of a subsidy screen shot for the subsidy module of the human service provider server.

### DETAILED DESCRIPTION

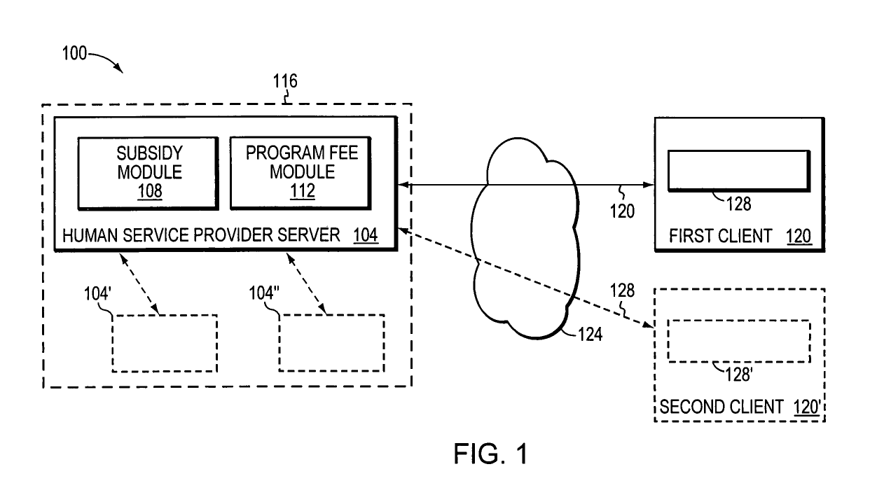

FIG. 1 is a conceptual block diagram depicting an exemplary computer system 100 that tracks and reports outcomes of individuals. The illustrative computer system 100 includes a human service provider server 104 used by a human service provider. The human service provider is a provider of a comprehensive range of services to people with mental illness, mental retardation, and behavioral health disabilities, as well as to their families, neighbors, and communities. For example, a human service provider can provide services to assist adults and children with mental retardation, autism, and secondary disorders such as behavioral challenges, blindness, deafness, and epilepsy. A human service provider can provide both residential and day programs tailored to individual and family needs and circumstances. For example, the residential services can include facilities for adults to live with an on-site staff to help care for the residents. The human service provider can also include day habilitation services focused on basic skills training, such as speech, occupational therapy, and medical issues.

The server 104 can record and track a wide range of client outcome data and provide a tool for analyzing trends associated with the data. The server 104 can further assist with accountability to payers and clients, management decisions, risk management, benchmarking, cost management, and accreditation standards. Moreover, the server 104 can additionally track subsidies, program fees, risk data, and utilization.

The server 104 includes a subsidy module 108 and a program fee module 112. As described in more detail below, the subsidy module 108 facilitates the acquisition and maintenance of information regarding various subsidies that are connected to the clients. In particular, when housing for a client A expires or if client A moves, the subsidy module 108 tracks who (i.e., which other client) fills that spot. The subsidy module 108 receives subsidies from subsidy providers (e.g., the Boston Housing Authority). The program fee module 112 maintains records pertaining to calculating and collecting a program fee for a service provided by a human service provider. The program fee is an amount used to defer a client's costs for particular items, such as meals and/or rent.

The server 104 may also be part of a server farm 116, or server network, which is a logical group of one or more servers that are administered as a single entity. In one embodiment, the server farm 116 includes a total of three servers 104, 104′, 104″ (generally 104). Although the embodiment shown in FIG. 1 has three servers 104, the server farm 116 can have any number of servers. In other embodiments, the server farm 116 is a protected network that is inaccessible by unauthorized individuals, such as a corporate Intranet, Virtual Private Network (VPN), or secure extranet. Additionally, the servers making up the server farm 116 may communicate over any of the networks described above (e.g., WAN, LAN) using any of the protocols discussed.

The server 104 can communicate with one or more clients (e.g., a first client 120 and a second client 120′ (generally client 120)) over a network 124. More specifically, the server 104 may support communications over a local-area network (LAN), a medium-area network (MAN), or a wide area network (WAN) such as the Internet or the World Wide Web in accordance with conventional, well-known protocols.

The client 120 can be any computing device, such as a desktop computer, a laptop, a personal digital assistant, a cellular telephone, etc. that communicates with the human service provider server 104. In one embodiment, a staff member of the human service provider operates the client 120. Each client 120, 120′ can also include a respective web browser 128, 128′ (generally 128), such as INTERNET EXPLORER developed by Microsoft Corporation in Redmond, Wash., to connect to the web and/or download content from the server 104. The server 104 typically delivers web pages to the client 120 (e.g., web browser 128) in response to a communication request from the client 104.

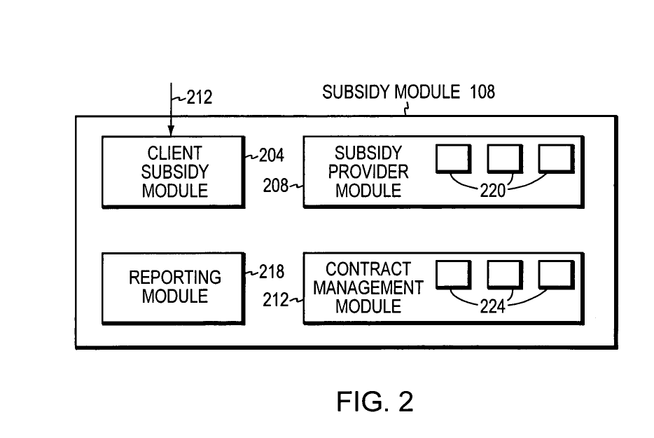

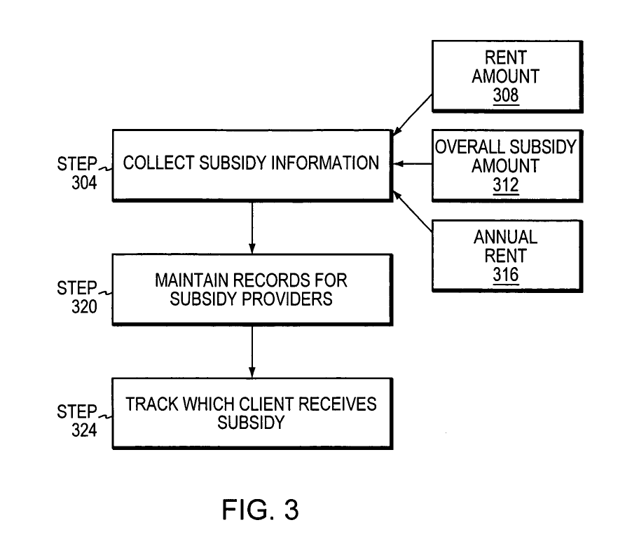

Referring to FIGS. 2 and 3, the subsidy module 108 includes a client subsidy module 204, a subsidy provider module 208, a contract management module 212, and a reporting module 218. The software modules described above and below can be written in any programming language, such as Java or C++.

The client subsidy module 204 receives and collects information 212 related to subsidies (i.e., subsidy information 212) for clients of the human service provider (step 304). In one embodiment, the subsidy information 212 includes one or more of a monthly rent amount 308 for a particular property, overall subsidy amount 312, and/or total annual rent 316 for a particular property. The client subsidy module 204 can also maintain landlord information, such as a landlord's contact information (e.g., phone number, address, email address, etc.) and previously charged rent.

The subsidy provider module 208 maintains subsidy provider records 220 for subsidy providers providing subsidies to the human service provider (step 320). The subsidy provider records 220 can include, for instance, subsidy provider contact information and/or a list of subsidy types provided by the subsidy providers.

The contract management module 212 maintains contract records 224 for contracts associated with the subsidies. The contract records 224 can include information about one or more cost center attached to a contract associated with a subsidy. Moreover, a functional business unit module can track these cost centers. In one embodiment, a cost center is a logical subdivision of an organization that represents a location or activity that the organization wishes to account for. The accounting can include the maintenance of accounting records for a given entity that establishes the cost or net revenue or the disposition of funds in its custody. Accounting records can include records related to revenue(s), expense(s) and/or expenditure(s).

The reporting module 218 generates one or more reports associated with the subsidies. For example, the reporting module 218 can generate graphs (e.g., reconcilliation, accounts receivable, subsidy portion by client, and clients receiving specific subsidies) to plot out subsidy information.

The subsidy module 108 then tracks which client receives a subsidy (step 324). For instance, the subsidy providers may send a subsidy check to the human service provider without information as to which client or clients should get the benefit of the check. The subsidy module 108 uses its records and/or its subsidy information to determine which client receives the subsidy. For example, if the subsidy provider has only provided subsidies for three particular clients, the subsidy provider module 208 can determine this information from its records. The client subsidy module 204 can then determine, for example, the last time each of the three clients received a subsidy. From this information, the subsidy module 108 can determine which client(s) receive the current subsidy.

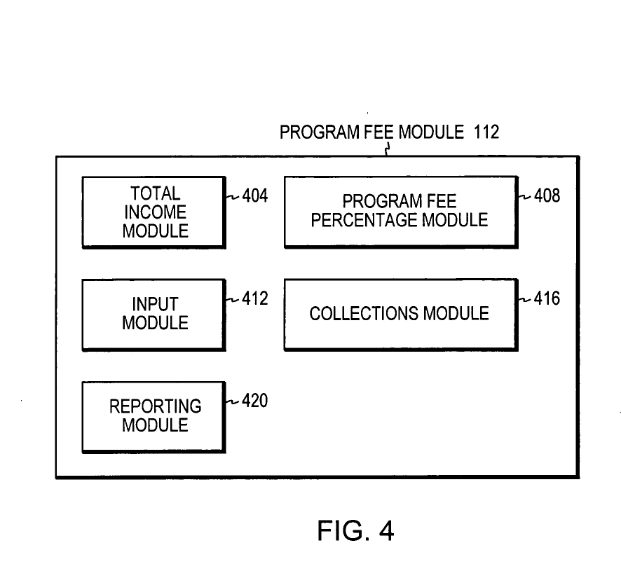

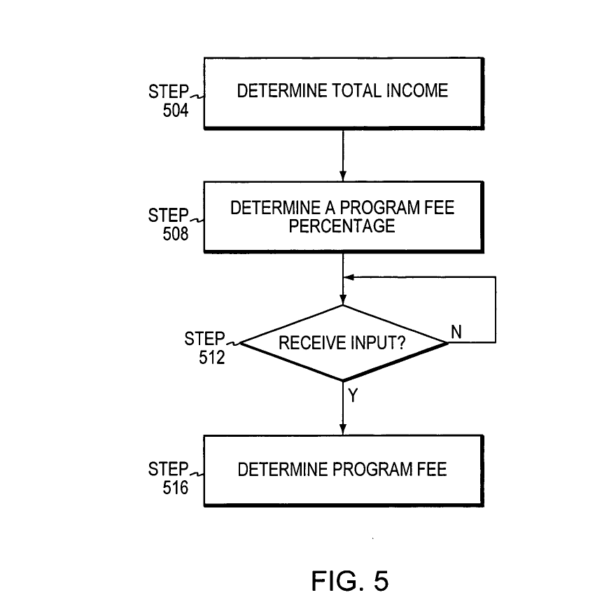

Referring to FIGS. 4 and 5, the program fee module 112 includes a total income module 404, a program fee percentage module 408, an input module 412, a collections module 416, and a reporting module 420. The total income module 404 determines a total income (step 504) and the program fee percentage module 408 determines a program fee percentage (step 508). In one embodiment, the input module 412 then receives one or more inputs (step 512) associated with the program fee calculation. In one embodiment, the program fee module 112 loops until an input is received in step 512. The program fee module 112 then determines the program fee (step 516). Alternatively, in another embodiment, the program fee module 112 calculates a program fee after a predetermined amount of time. Thus, if the input module 412 does not receive an input, the program fee module 112 calculates the program fee after a predetermined amount of time.

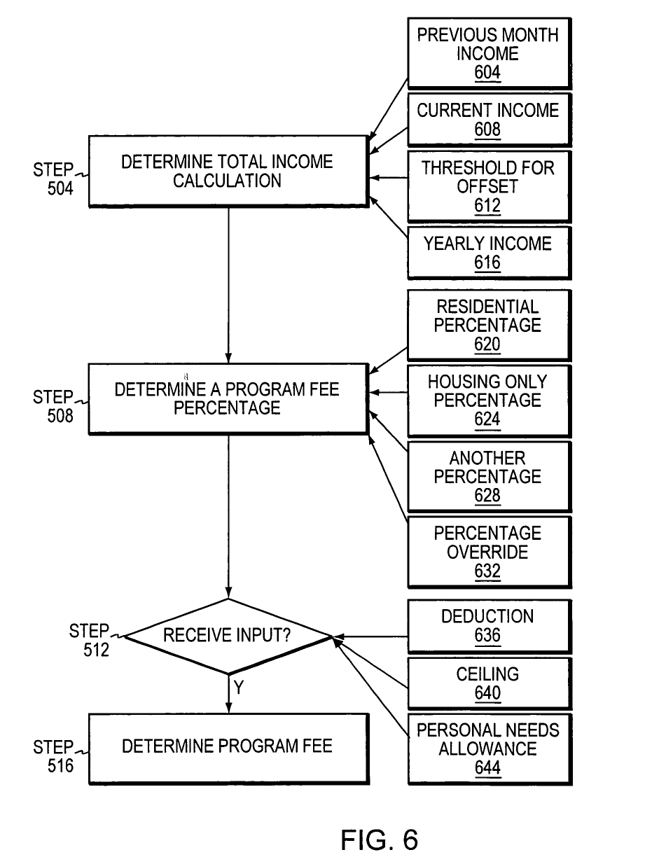

FIG. 6 is a flow chart illustrating an embodiment of items that the program fee module 112 can use in the calculation of the program fee. For example, to determine the total income, the total income module 404 may use either the client's previous month's income 604 or the current income 608, a threshold for offset 612, and a client's yearly income 616.

As described above, the program fee percentage module 408 calculates a program fee percentage for the program (step 508). In one embodiment, the program fee percentage module 408 can determine the program fee percentage from a residential percentage 620. The residential percentage 620 can include, for instance, a Department of Mental Retardation (DMR) percentage and/or a Department of Mental Health (DMH) percentage. The program fee percentage module 408 can also use a housing only percentage 624 to determine the program fee percentage. The housing only percentage 624 may include a supported housing percentage, a subsidy percentage, and/or a supported housing with subsidy percentage. In yet another embodiment, the program fee percentage module 408 uses a housing only percentage 624 and a percentage for services.

The program fee percentage module 408 may also include a percentage override 632 in its calculation of the program fee percentage. The percentage override 632 may be an input that overrides a previously determined program fee percentage. For example, a user can input a percentage override 632 for a particular situation, such as when a specific program fee is negotiated for one of many clients residing in a residential program. Another example of a use of the override function is a contractual requirement for a variation on the percentage or a special set of circumstance determined by the individual's treatment/service plan.

The residential percentage, the housing only percentage, and/or the percentage override varies depending on the funding agency, one or more contracts, the type of housing provider, and/or the type of service provider.

As described above, the program fee module 112 then accepts inputs (step 512). These inputs can include a deduction 636, a ceiling 640, and a personal needs allowance 644. The deduction 636 can be recurring or a one-time deduction. Examples of the deduction 636 include an earned income, a prescribed medication cost, the cost associated with attending work, and/or the cost associated with attending a recurring medical appointment.

In one embodiment, a user can enter an earned income rule to provide a rule for use in determining the program fee. The earned income rule can include Supplemental Security Income (SSI) and/or Social Security disability benefits (SSDI). For example, the program fee module 112 can deduct earned income and then credit $1 for every $2 earned with SSI and/or SSDI. In other embodiments, the earned income rule is not applied when someone reaches a particular income. In a further embodiment, the earned income rule is not applicable if the income earned under a predetermined amount is deducted completely. Other deductions 636 include prescribed medication costs not covered by Medicaid and/or deductions 636 approved by a particular officer of the human service provider (e.g., Divisional Vice President). Further, the deduction 636 can be one-time or recurring.

In one embodiment, the ceiling 640 is a maximum amount for the program fee percentage. The ceiling 640 may also be a maximum amount for any of the other inputs or variables that the program fee module 112 uses to determine the program fee, such as the program fee percentage, total income calculation, deduction 636, personal needs allowance 644, etc. In one embodiment, the ceiling 640 defaults to zero.

In one embodiment, the personal needs allowance has a predetermined amount (e.g., $100) remaining after the program fee. In one embodiment, the minimum personal needs allowance is determined by a state purchasing agency contract. In one embodiment, after the program fee is calculated, the reporting module provides an agreement that the client signs.

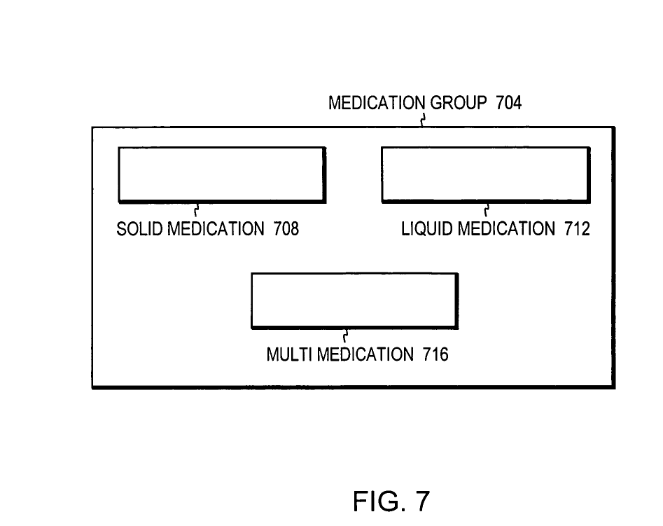

Referring to FIG. 7, a medication group 704 includes a solid medication 708, a liquid medication 712, and a multi medication 716. These groups, as further described below, are the types of medication that the human service provider server 104 manages. The multi medication 716 includes medications that include several medicines, such as Tylenol® with Codeine.

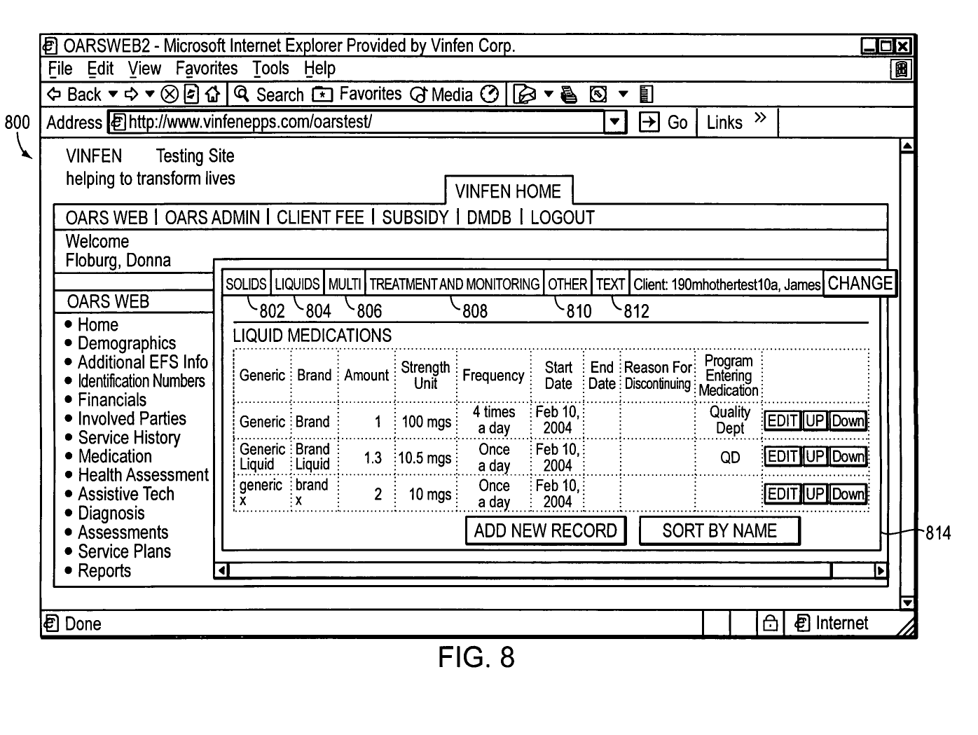

Referring to FIG. 8, a medication page 800 includes a Solids tab 802, a Liquids tab 804, a Multi tab 806, a Treatment and Monitoring tab 808, an Other tab 810, and a Text tab 812. The Solids tab 802 and the Liquids tab 804 enable a user to input information associated with a client's solid medication and a client's liquid medication. The Multi tab 806 enables a user to enter information for medications that contain multiple medicines, as described above. Further, the Treatment and Monitoring tab 808 enables a user to enter information about the treatment and/or monitoring of a client and the client's medications or non-medication treatments, such as glucometer, blood pressure, weight, and intramuscular medication. Moreover, a client may also be able to take other medications that are not critical. The Other tab 810 enables a user to input information about medication for which the program does not administer and/or has no doctor's orders for. The Text tab 812 enables a user to enter medication or treatment information for a category other than solid, liquid, or multi medication.

The medication page 800 illustrates a medication area 814 for liquid medications (e.g., when the user selects the Liquids tab 804). The medication area 814 includes a display of the information associated with the liquid medications of a particular client, such as a generic name, the brand name, amount taken, the strength, unit, frequency of times the medication should be taken, a start and end date, a reason for discontinuing, and which program entered the medication. For instance, a user can input that a liquid medication has a strength of 250 mg/5 cc. Although the previous categories are mentioned above, any number of categories of any type can be included in the medication area 814.

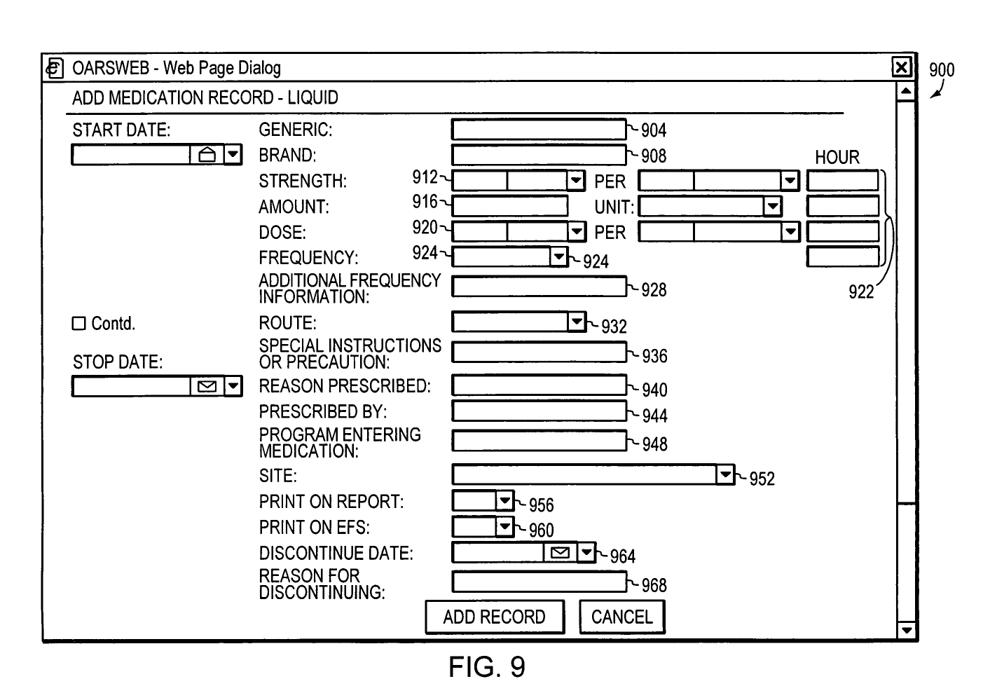

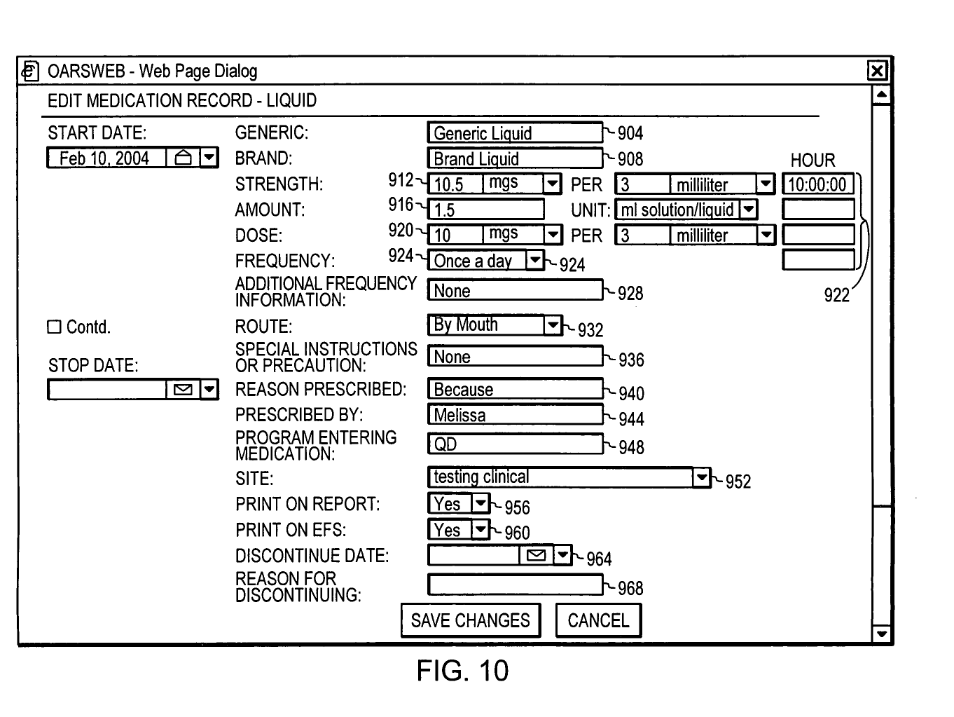

Referring to FIG. 9, a user enters data into a liquids data entry screen 900. The data entry screen 900 includes a generic entry box 904, a brand entry box 908, a strength entry box 912, an amount entry box 916, a dose entry box 920, a time entry box 922, a frequency entry box 924, additional frequency information 928, a route entry box 932, a special instructions box 936, a reasons prescribed entry box 940, a prescribed by entry box 944, a program entering medication entry box 948, a site entry box 952, a print on report entry box 956, a print on EFS entry box 960, a discontinue date entry box 964, and a reason for discontinuing entry box 968. Moreover, the data entry screen 900 can include any combination of the above entry boxes 904-968. FIG. 10 illustrates an embodiment of the liquids data entry screen 900 with some of the entry boxes 904-968 entered.

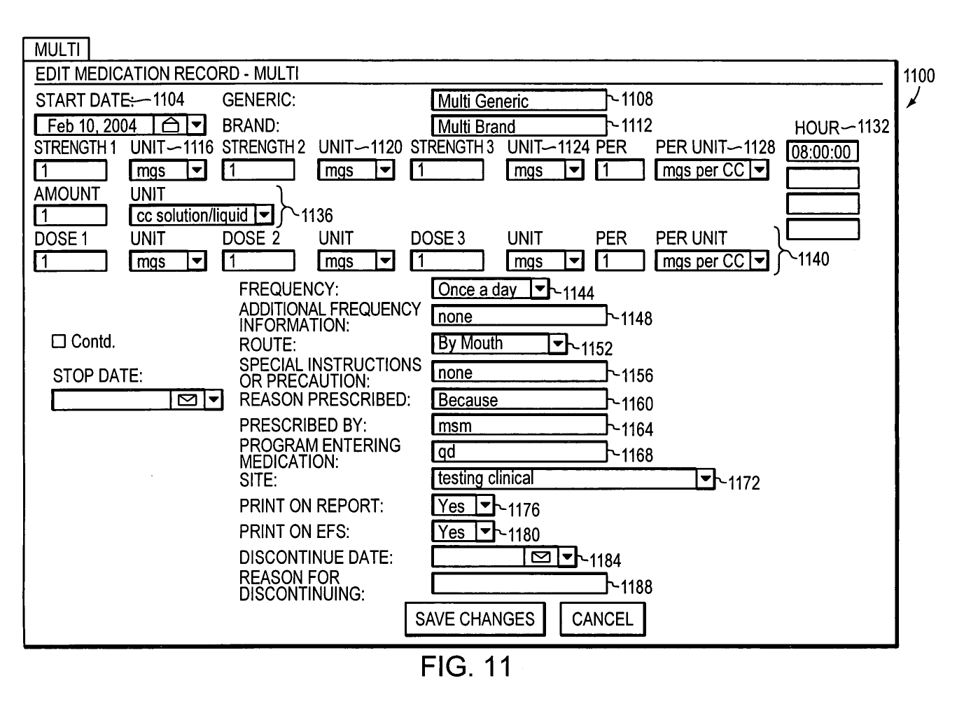

Referring to FIG. 11, some medications that a client takes may contain multiple medicines within a single medication. As described above, the Multi tab 806 enables a user to enter information for these types of medications. A multi data entry screen 1100 can include several dialog entry boxes, such as dialog entry boxes 1104-1188. The dialog entry boxes can include, for example, a start date entry box 1104, a generic entry box 1108, a brand data entry box 1112, and several strength entry boxes (e.g., a first strength entry box 1116, a second strength entry box 1120, and a third strength entry box 1124). In the embodiment shown, the strength entry boxes 1116-1124 include a strength field and a unit field (e.g., mgs).

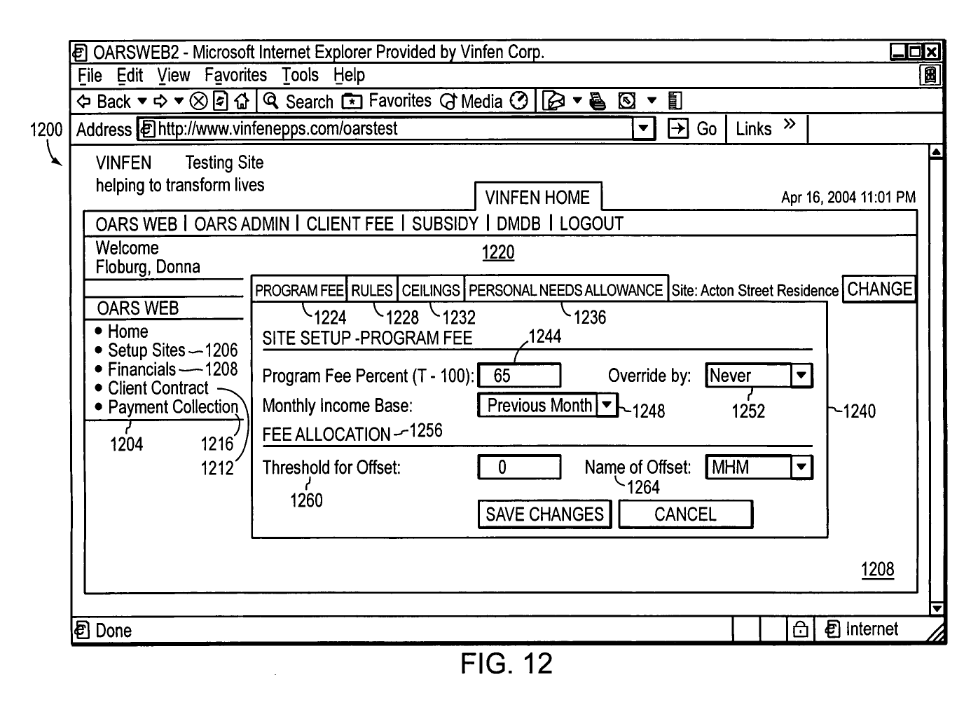

FIG. 12 illustrates a site setup screen shot 1200 of the program fee module 112. The screen shot 1200 includes an option bar 1204 and a main window 1208. The option bar 1204 depicts the options available to a user of the program fee module 112. The option bar 1204 includes a site setup option 1206, a financials option 1208, a client contract option 1212, and a payment collections option 1216.

The main window 1208 includes a tab bar 1220 having a program fee tab 1224, a rules tab 1228, a ceilings tab 1232, and a personal needs allowance tab 1236. Each tab 1224-1236 enables a user to input information related to the tab. For instance, the program fee tab 1224 for the site setup option 1204 includes input areas 1240 for the program fee percentage 1244, the monthly income base 1248, percentage override 1252 and a fee allocation area 1256 including a threshold for offset 1260 and a name of offset 1264.

The rules tab 1228 enables an administrator to define a work rule by, e.g., entering an earned income, a rule, and/or a minimum income threshold. The personal needs allowance tab 1236 enables an administrator to enter personal needs allowances, such as whether an override is allowed.

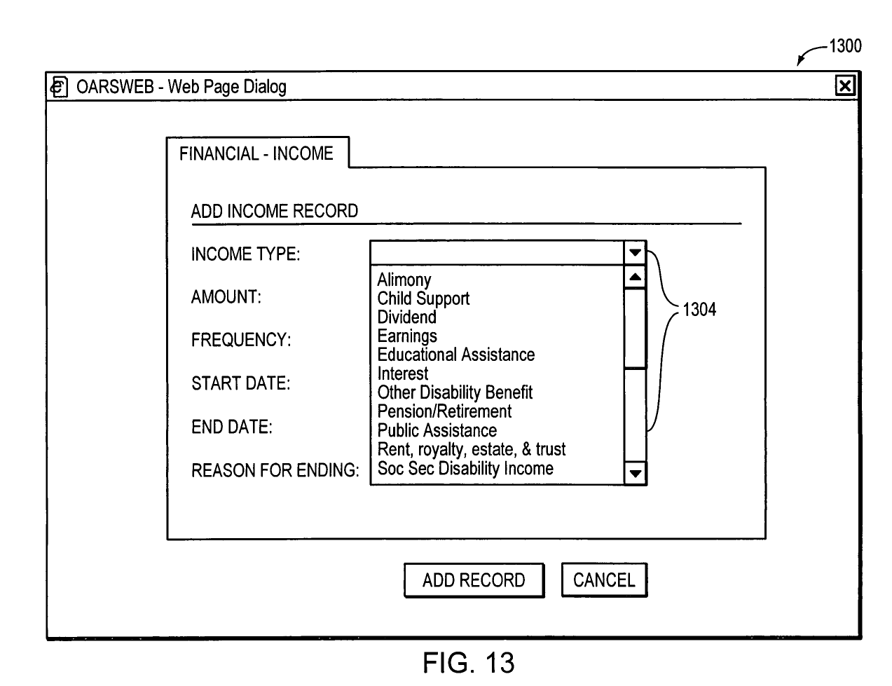

Referring to FIG. 13, a financial income screen 1300 includes a sample list of income types 1304 as well as additional financial information. These include alimony, child support, dividend, earnings, educational assistance, interest, other disability benefit, pension/retirement, public assistance, rent, royalty, estate and trust, and social security disability income.

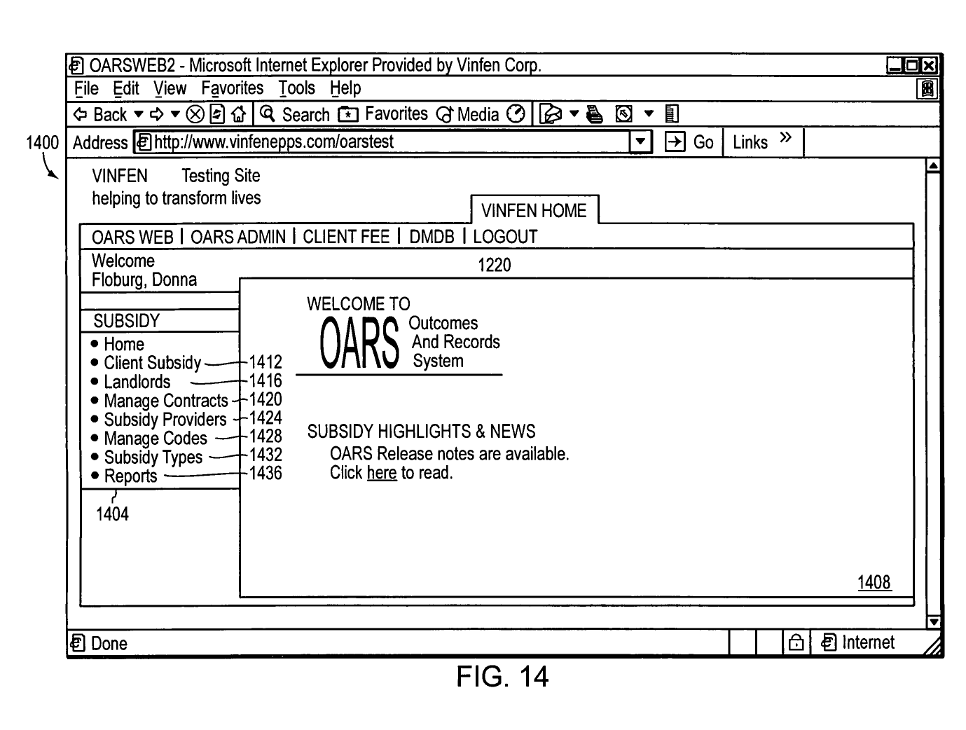

FIG. 14 illustrates a subsidy screen shot 1400 for the subsidy module 108. The subsidy screen shot 1400 includes an option bar 1404 and a main window 1408. The option bar 1404 depicts the options available to a user of the subsidy module 108. The option bar 1404 includes a client subsidy option 1412, a landlords option 1416, a manage contracts option 1420, a subsidy provider option 1424, a manage codes option 1428, a subsidy type 1432, and a reports option 1436. These enable a user with exemplary options related to the subsidy module 108.

Having described certain embodiments of the invention, it will now become apparent to one of skill in the art that other embodiments incorporating the concepts of the invention may be used. Therefore, the invention should not be limited to certain embodiments, but rather should be limited only by the spirit and scope of the following claims.

1. A method for tracking, by a software module, a program fee for a service provided by a human service provider comprising:
(a) determining a total income and a program fee percentage associated with the service;
(b) enabling a user to input at least one of a deduction, a ceiling, and a personal needs allowance; and
(c) determining, by a software module, a program fee for the service using at least one of the total income, program fee percentage, deduction, ceiling, and personal needs allowance.

2. The method of claim 1 wherein determining the total income further comprises using at least one of a previous month income, current income, threshold for offset, and yearly income.

3. The method of claim 1 wherein the determining of the program fee percentage further comprises determining at least one of a residential percentage, a housing only percentage, and a percentage override.

4. The method of claim 3 wherein the determining of the residential percentage further comprises determining at least one of a Department of Mental Retardation (DMR) percentage and a Department of Mental Health (DMH) percentage.

5. The method of claim 3 wherein the determining of the housing only percentage further comprises determining at least one of a supported housing percentage, a subsidy percentage, and a supported housing with subsidy percentage.

6. The method of claim 3 wherein the at least one of the residential percentage, the housing only percentage, and the percentage override varies depending on at least one of a funding agency, a contract, type of housing provider, and type of service provider.

7. The method of claim 1 further comprising enabling the user to input an earned income rule.

8. The method of claim 1 wherein the deduction further comprises determining at least one of type of and amount of the deduction.

9. The method of claim 1 wherein the deduction is at least one of a recurring deduction and a one-time deduction.

10. A software module to determine a program fee for a service provided to a client by a human service provider comprising:
(a) a total income module calculating a total income for a client of a human service provider;
(b) a program fee percentage module calculating a program fee percentage for a service provided to the client by the human service provider; and
(c) an input module enabling input of at least one of a deduction, a ceiling, and a personal needs allowance; and
(d) a program fee module determining a program fee for the service using at least one of the total income, program fee percentage, deduction, ceiling, and personal needs allowance.

11. The software module of claim 10 further comprising a collections module determining whether the program fee is collected.

12. The software module of claim 10 wherein the program fee percentage further comprises at least one of a residential percentage, a housing only percentage, another percentage, and a percentage override.

13. The software module of claim 10 wherein the deduction further comprises at least one of an earned income, a prescribed medication cost, and a cost associated with at least one of attending work and attending a recurring medical appointment.

14. A method for maintaining information related to subsidies for a plurality of clients of a human service provider comprising:
(a) collecting information related to subsidies for clients of a human service provider;
(b) maintaining records for subsidy providers providing subsidies to the clients of the human service provider; and
(c) determining, by a subsidy module, which client receives a subsidy from at least one of the information related to the subsidies and the subsidy provider records.

15. The method of claim 14 wherein the collecting of information related to the subsidies further comprises collecting at least one of rent amount, overall subsidy amount, and annual rent.

16. The method of claim 14 further comprising maintaining landlord information.

17. The method of claim 14 wherein the maintaining of records further comprises maintaining a list of subsidy types provided by the subsidy providers.

18. The method of claim 14 further comprising maintaining contract records for contracts associated with the subsidies.

19. The method of claim 14 further comprising generating reports associated with the subsidies.

20. A subsidy module comprising:
(a) a client subsidy module collecting information related to subsidies for clients of a human service provider; and
(b) a subsidy provider module maintaining records for subsidy providers providing subsidies to the clients of the human service provider,
wherein the subsidy module determines which client receives a subsidy from at least one of the information related to the subsidies and the subsidy provider records.

21. The subsidy module of claim 20 wherein the information related to the subsidies further comprises at least one of rent amount, overall subsidy amount, and annual rent.

22. The subsidy module of claim 20 wherein the records for subsidy providers further comprises a list of subsidy types provided by the subsidy providers.

23. The subsidy module of claim 20 further comprising a contract management module maintaining contract records for contracts associated with the subsidies.

24. The subsidy module of claim 23 wherein the contract records further comprises at least one cost center attached to a contract associated with a subsidy.

25. The subsidy module of claim 20 further comprising a reporting module generating reports associated with the subsidies.

26. The subsidy module of claim 20 further comprising inputs of a subsidy start date, a subsidy end date, and a subsidy recertification date.
